(19) United States
(12) Patent Application Publication
(10) Pub. No.: US 2009/0278769 A1
(43) Pub. Date: Nov. 12, 2009

(54) Digital picture frame system

(76) Inventor: Chung-Jen Huang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/149,634

(22) Filed: May 6, 2008

(51) Int. Cl. G09G 3/30

(52) U.S. Cl. 345/76

(57) ABSTRACT

A digital picture frame system includes a storage unit, a display unit, a control unit, a first port, a first user interface and a power supply unit. The control unit is electrically connected with the storage unit and the display unit to access the storage unit and deliver a picture to the display unit to display. The first port electrically connected to the control unit is used for electrically connecting to an external electronic device. The first user interface electrically connected to the control unit is used for sensing motion of the digital picture frame system or voice to operate the digital picture frame system. The power supply unit electrically connected to the control unit is used for providing a power required for the operation of the digital picture frame system. The above-mentioned digital picture frame system is operated by shaking or voice activation, in a preferred embodiment, further can process picture with special efficacy, therefore there are increased interaction and interest.

### BACKGROUND OF THE INVENTION

1. Field of the Invention

The present invention relates to a digital picture frame system, particularly to a digital picture frame system which increases the operation interaction with users.

2. Description of the Prior Art

Digital cameras are easy to use and can play pictures instantly, consequently electronic devices with the function of digital camera are more and more popular. Peripheral devices of related digital camera are also universal, for instance, digital picture frame.

A digital picture frame provides a convenient and economical way to share pictures. However a digital picture frame of prior art can only steadfastly display the storaged pictures and is the button way for users to conduct various operations, therefore a digital picture frame of prior art is monotonous, lacking of interaction with users as well as fun and consisted of more parts.

To summarize the foregoing descriptions, the main goal of the present invention is to increase the interaction with users and reduce the parts of the digital picture frame.

### SUMMARY OF THE INVENTION

One objective of the present invention is to provide a digital picture frame system which is operated by sensing motion or voice, therefore there are increased operation interaction and reduced parts in the digital picture frame system.

Another objective of the present invention is to provide a digital picture frame system which includes a picture processing module used for processing a picture with special efficacy, therefore there are increased operation interaction and interest of the digital picture frame system.

To achieve the above-mentioned objective, according to one embodiment of the present invention the proposed digital picture frame system includes a storage unit, a display unit, a control unit, a first port, a first user interface and a power supply unit. The control unit is electrically connected with the storage unit and the display unit to access the storage unit and to deliver a picture to the display unit to display. The first port electrically connected to the control unit is used for electrically connecting to an external electronic device. The first user interface electrically connected to the control unit is used for sensing motion of the digital picture frame system or voice to operate the digital picture frame system. The power supply unit electrically connected to the control unit is used for providing a power required for the operation of the digital picture frame system.

The objective, technologies, features and advantages of the present invention will become apparent from the following description in conjunction with the accompanying drawings wherein are set forth, by way of illustration and example, certain embodiments of the present invention.

### BRIEF DESCRIPTION OF THE DRAWINGS

The foregoing conceptions and their accompanying advantages of this invention will become more readily appreciated after being better understood by referring to the following detailed description, in conjunction with the accompanying drawings, wherein:

FIG. 1 is a block diagram schematically showing a digital picture frame system according to a preferred embodiment of the present invention; and

FIG. 2 is a block diagram schematically showing a digital picture frame system according to another preferred embodiment of the present invention.

### DESCRIPTION OF THE PREFERRED EMBODIMENT

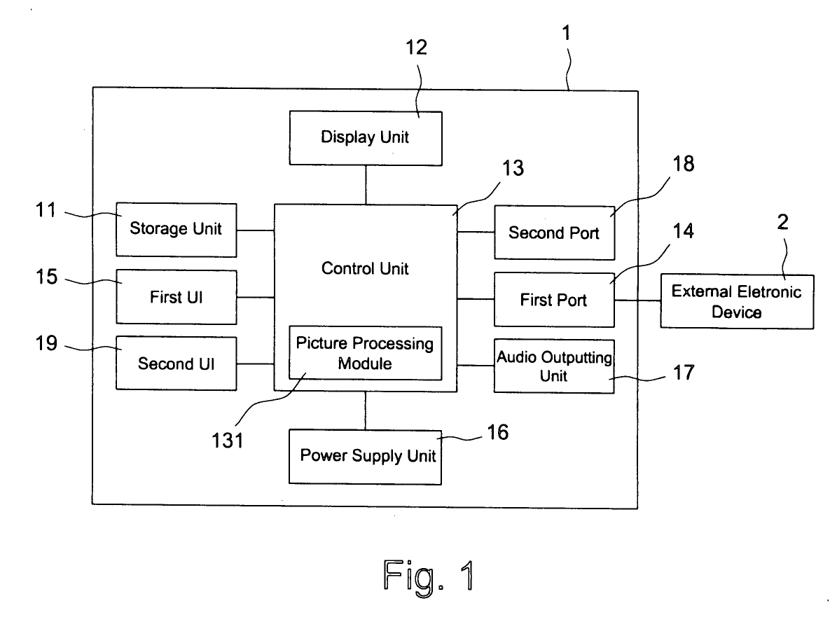

Referring to FIG. 1, according to one embodiment of the present invention the proposed digital picture frame system 1 includes a storage unit 11, a display unit 12, a control unit 13, a first port 14, a first user interface 15 and a power supply unit 16. The storage unit 11, such as flash memory, hard disk or memory card etc., is used for storing a picture. The display unit 12 is used for displaying the picture, which can be designed into a variety of sizes, such as 1.1-inch to 8-inch, based on requirements. The digital picture frame system 1 with large-size display unit 12 can be a decoration on the desk and with small-size display unit 12 can be a personal ornament, like key ring or necklace pendant etc. In a preferred embodiment, the display unit 12 can be a color super twisted nematic liquid crystal display (CSTN LCD), a thin film transistor liquid crystal display (TFT LCD) or an organic light-emitting diode (OLED) panel.

The control unit 13 is electrically connected with the storage unit 11 and the display unit 12 and used for accessing the storage unit 11 and delivering the picture to the display unit 12 to display. The first port 14 is electrically connected with the control unit 13 and used for electrically connected to a external electronic device 2, and in consequence the picture stored in the external electronic device 2 can be delivered to the storage unit 11 of the digital picture frame system 1 via the first port 14. For example, the first port 14 can be a universal serial bus (USB) port or an IEEE 1394 port.

The first user interface 15 is electrically connected with the control unit 13 and used for sensing motion or voice, so as to operate the digital picture frame system 1 via the first user interface 15 by a user. For example, the first user interface 15 can be a vibration sensor, a ball switch, a gradient sensor or a microphone etc., so that the user can operate the digital picture frame system 1 by the strength and/or direction of shaking or voice activation. The power supply unit 16 is electrically connected with the control unit 13 and used for providing a power required for the operation of the digital picture frame system 1. For example, the power supply unit 16 can be a rechargeable battery or a disposable battery.

Referring to FIG. 1 again, the digital picture frame system 1 of the present invention further includes a picture processing module 131, in this embodiment, the picture processing module 131 is integrated with the control unit 13. The picture processing module 131 is used for processing the picture with special efficacy to output a special efficacy picture. For example, the picture processing module 131 can automatically detect features of human face, such as hair, eyes, nose, mouth and ears etc., and morph the facial features with special efficacy to output the special efficacy picture, such as vampire, witch, punk hair, raising eyebrows, winking, long nose etc. Furthermore, the picture processing module 131 can integrate a plurality of the pictures or the special efficacy pictures into an animation picture. The special efficacy picture made from the picture processing module 131 can be displayed directly on the display unit 12, and can be stored in the storage unit 11.

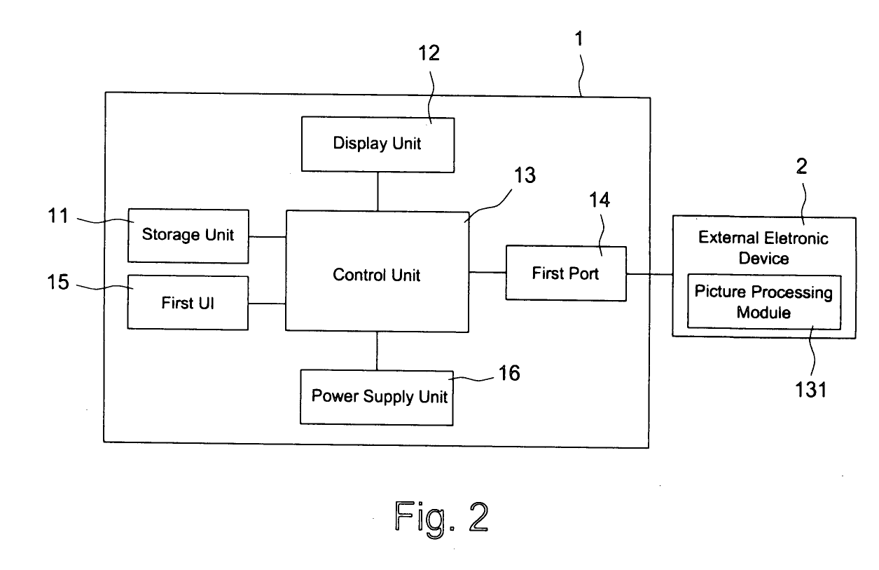

It should be noticed that the picture processing module 131 not only is integrated in the control unit 13, but also can be arranged in the external electronic device 2, as shown in FIG. 2. And then, the special efficacy picture made from the picture processing module 131 can be delivered to the digital picture frame system 1 via the first port 14. In one embodiment, the external electronic device 2 can be a computer, a personal digital assistant (PDA), a digital camera or a mobile phone etc., and the picture processing module 131 can be implement by the software.

Referring to FIG. 1 again, the digital picture frame system 1 of the present invention further includes an audio outputting unit 17 which is electrically connected to the control unit 13 and used for outputting a sound. When the user operates the digital picture frame system 1 by shaking or the special efficacy picture is displaying, the audio outputting unit 17 can play a special sound or a designated sound, so as to increase the interaction and interest of the digital picture frame system 1 of the present invention. For example, the audio outputting unit 17 can be a speaker.

The digital picture frame system 1 of the present invention further includes a second port 18 which is electrically connected with the control unit 13 and used for proceeding a wireless communication with the external electronic device 2 or another digital picture frame system 1. For example, the second port 18 can be an infrared ray port, a bluetooth module or a wireless local area network (WLAN) module. According to the above-mentioned structure, the digital picture frame system 1 of the present invention can not only be connected to the external electronic device 2 by the wireless communication, but also share the picture or the special efficacy picture with other digital picture frame system 1.

The digital picture frame system 1 of the present invention further includes a second user interface 19 which is electrically connected with the control unit 13. The second user interface 19 is profiled as a conventional button type so that the user can operate the digital picture frame system 1 by a plurality of buttons.

To summarize the foregoing descriptions, the digital picture frame system of the present invention includes fewer parts and can be operated by shaking or voice activation. Furthermore, in a preferred embodiment, the digital picture frame system of the present invention can process picture with special efficacy so it can display different special efficacy picture when shaking, and therefore there are increased interaction and interest of the digital picture frame system.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A digital picture frame system comprising:
a storage unit used for storing at least one picture;
a display unit used for displaying the picture;
a control unit electrically connected with the storage unit and the display unit and used for accessing the storage unit and delivering the picture to the display unit to display;
a first port electrically connected with the control unit and used for electrically connected to an external electronic device;
a first user interface electrically connected with the control unit and used for sensing motion of the digital picture frame system or voice to operate the digital picture frame system; and
a power supply unit electrically connected with the control unit and used for providing a power required for the operation of the digital picture frame system.

2. A digital picture frame system according to claim 1, further comprising a picture processing module used for processing the picture with special efficacy to output a special efficacy picture.

3. A digital picture frame system according to claim 2, wherein the picture processing module is integrated with the control unit.

4. A digital picture frame system according to claim 2, wherein the picture processing module is arranged in the external electronic device, and the special efficacy picture is delivered to the digital picture frame system via the first port.

5. A digital picture frame system according to claim 4, wherein the picture processing module is implement by the software.

6. A digital picture frame system according to claim 4, wherein the external electronic device is a computer, a personal digital assistant, a digital camera or a mobile phone.

7. A digital picture frame system according to claim 1, wherein the first user interface is a vibration sensor, a ball switch, a gradient sensor or a microphone.

8. A digital picture frame system according to claim 1, further comprising an audio outputting unit electrically connected to the control unit and used for outputting a sound.

9. A digital picture frame system according to claim 8, wherein the audio outputting unit is a speaker.

10. A digital picture frame system according to claim 1, further comprising a second port electrically connected with the control unit and used for proceeding a wireless communication with the external electronic device or another digital picture frame system.

11. A digital picture frame system according to claim 10, wherein the second port is an infrared ray port, a bluetooth module or a wireless local area network module.

12. A digital picture frame system according to claim 1, wherein the first port is a USB port or an IEEE 1394 port.

13. A digital picture frame system according to claim 1, further comprising a second user interface electrically connected with the control unit and used for operating the digital picture frame system by a plurality of buttons.

14. A digital picture frame system according to claim 1, wherein the storage unit is a flash memory, a hard disk or a memory card.

15. A digital picture frame system according to claim 1, wherein the display unit is a color super twisted nematic liquid crystal display, a thin film transistor liquid crystal display or an organic light-emitting diode panel.

16. A digital picture frame system according to claim 1, wherein the power supply unit is a rechargeable battery or a disposable battery.
